(19) United States
(12) Patent Application Publication
(10) Pub. No.: US 2019/0200572 A1
(43) Pub. Date: Jul. 4, 2019

(54) CANINE BALLISTIC CARRIER VEST

(71) Applicant: Central Lake Armor Express, Inc., Central Lake, MI (US)

(72) Inventor: Michael A. Criswell, Bellaire, MI (US)

(21) Appl. No.: 15/857,813

(22) Filed: Dec. 29, 2017

(51) Int. Cl. A01K 13/00; A01K 27/00

(52) U.S. Cl. CPC A01K 13/006; A41D 31/0011; A01K 27/002

(57) ABSTRACT

A canine ballistic carrier vest assembly includes a torso section for overlying a torso of the canine which includes a length dimension for extending along a length of a back of the canine and a width dimension for extending about opposing first and second sides of the torso of the canine, with the torso section positioned on the canine, such that the torso section which extends about the first side extends to a first end portion and the torso section which extends about the second side extends to a second end portion. A first loop is associated with the first end portion of the torso section, a second loop is associated with the second end portion of the torso section, and a lace member has a first portion for extending through the first loop and has a second portion for extending through the second loop.

### FIELD

This disclosure relates to a canine ballistic carrier vest and more particularly to a canine ballistic carrier vest which provides adjustable securement with a streamlined profile.

### BACKGROUND

Ballistic resistant vests are a necessity in the work performance of dogs placed in combat zones or work with law enforcement authorities in carrying out law enforcement activities and security duties. Ballistic resistant vests typically include a ballistic resistant carrier vest assembly which carries ballistic resistant panels strategically positioned to provide the canine ballistic protection. The canine is often the first to be present in an area of conflict danger and/or ballistic threat. Ballistic resistant vests for canines are typically secured to the canine with the use of a number of buckles that strap the carrier, which carries ballistic padding, snuggly to canine. The individual buckles can take time for the handler to secure and unsecure. Time in a combative zone, for example, can be a commodity that is not readily available.

A buckle and securement strap assembly has limitations such as with respect to fit. The assembly is limited typically by the spacing between holes, for example, on the strap which will dictate how closely that portion of the carrier will be positioned with respect to the canine's torso. Thus, attaining a continuous snug fit to the canine can be a challenge particularly with the variance of the shape of the canine's body and the limitations presented by straps with finite spacing between holes which may not provide an optimal continuous snug fit. The continuous snug fit is preferable in confronting a ballistic threat. The snug continuous fit provides for the ballistic pads carried by the carrier to optimize their performance. A snug continuous fit will provide assurance of protective coverage for the canine at vital organ locations. The fit, at the same time, must not be overly tight so as to distract the canine or restrict their physical performance.

In other duties, where ballistic threat is not as high a probability to occur but possible physical exertion is required by the canine, the snug fit is not as required and a looser fit may be more appropriate. The looser fit can improve the canine's mobility and agility and can provide the canine the ability to take larger breathes as demanded by the exertion demands placed on the canine. As can be appreciated there is a need to be able to make adjustments of the carrier as needed by the particular duties being carried out by the canine in the field. These adjustments again need to be made reliably and sometimes quickly by the handler.

There is a need to be able to have a carrier that can adjust in size to fit different sized canine torsos. The torso shapes and sizes of various canines can vary and a particular carrier may need to be worn by one canine on one occasion and by a different canine on another occasion. With adjustable sizing, less cost is needed in purchasing carriers for an institution that has multiple canines on duty. Adjustments to the fit may need to be made to accommodate the size of the dog such as in the chest and neck region, for example, without needing to seek and obtain a different carrier to accommodate a canine having different dimensioned chest and neck sizes.

There is also a need to eliminate the profile of buckle and strap assemblies positioned on the exterior of the carrier vest. Buckles may extend away from the torso of the canine as may excess strap of the buckle assemblies. These items such as the buckle or excess strap extending away from the canine can create an entanglement threat to the canine in conducting the canine's maneuvering duties in the field. An entanglement of the canine can present a life threatening situation not only for the canine but also the canine's handler.

Reliable securement of the carrier to the dog is a high priority. Should a failure of securement occur during a time the canine is performing their duties, the canine may lose full protection otherwise provided by the ballistic padding carried by the carrier.

In addition, a canine placed in combat or in a law enforcement field environment will also need to be able to stow medical care and/or tracking items such as a transponder in order for the handler to be able to locate the dog at any time. Stow areas should not be readily seen for security purposes. The stow area should be strategically positioned so as not to create an entanglement danger for the canine and yet securely stow the important cargo such as medical equipment and/or sensitive electronic tracking equipment.

### SUMMARY

In an example, a canine ballistic carrier vest assembly includes a torso section for overlying a torso of the canine which includes a length dimension for extending along a length of a back of the canine with the torso section positioned on the canine. The torso section includes a width dimension for extending about opposing first and second sides of the torso of the canine with the torso section positioned on the canine, such that the torso section which extends about the first side extends to a first end portion and the torso section which extends about the second side extends to a second end portion. A first loop is associated with the first end portion of the torso section, a second loop is associated with the second end portion of the torso section, and a lace member has a first portion for extending through the first loop and has a second portion for extending through the second loop.

In an example, a canine ballistic carrier vest assembly includes a torso section for overlying a torso of the canine which includes a length dimension of the torso section for extending along a length of a back of the canine and a width dimension of the torso section for extending in a transverse direction relative to opposing sides of the length dimension for positioning the torso section about opposing sides of the torso of the canine with the torso section positioned on the canine. An abdomen and chest section includes a first portion of the abdomen and chest section which is positionable to overlie the abdomen of the canine having a length dimension which extends along a length of an abdomen of the canine with the chest and abdomen section positioned on the canine and the first portion is secured to the torso section with the torso section overlying the torso of the canine. A second portion of the abdomen and chest section extends in a transverse direction from opposing sides of the length dimension of the first portion of the abdomen and chest section. The second portion of the abdomen and chest section includes a first end portion and the torso section defines a first pocket for receiving at least a portion of the first end portion. The second portion of the abdomen and chest section includes a second end portion and the torso section defines a second pocket for receiving at least a portion of the second end portion.

In an example, a canine ballistic carrier vest assembly includes a torso section for overlying a torso of the canine which includes a length dimension of the torso section for extending along a length of a back of the canine and a width dimension of the torso section for extending about opposing first and second sides of the torso of the canine with the torso section positioned on the canine. The torso section includes a first component and a second component, which are in overlapping relationship to one another with the torso section positioned on the canine, with a zipper assembly, associated with the first component and the second component, having a length dimension, which extends along the length dimension of the torso section for releasably joining the first component and the second component together, wherein a portion of the zipper assembly is secured to an edge of one of the first or second components and another portion of the zipper assembly is secured spaced apart from an edge of the other of the one of the first or second components. A flap secured to one of the first or second components has a length dimension which extends along the length dimension of the zipper assembly, with the zipper assembly in a secured closed position joining the first and second components together wherein the flap has a width dimension such that with the flap positioned in overlying relationship with the torso section the flap overlies the zipper assembly in the secured closed position.

In an example, a canine ballistic carrier vest assembly which includes a panel secured to a portion of the canine ballistic carrier vest assembly along a line of securement between the portion of the ballistic carrier vest assembly and the panel. The line of securement between the panel and the portion of the ballistic carrier vest assembly forms an enclosure positioned between the portion of the ballistic carrier vest assembly and the panel. A gap is positioned in the line of securement between the panel and the portion of the ballistic carrier vest assembly which defines an opening between the panel and the portion of the ballistic carrier vest assembly wherein the opening is in communication with the enclosure. At least a portion of the panel is constructed of an elastomeric material.

The features, functions, and advantages that have been discussed can be achieved independently in various embodiments or may be combined in yet other embodiments further details of which can be seen with reference to the following description and drawings.

### BRIEF SUMMARY OF THE DRAWINGS

FIG. 1 is a perspective view of a canine ballistic carrier vest assembly of the present disclosure being worn by a canine;

FIG. 2 is an exploded disassembled bottom plan view of the canine ballistic carrier vest assembly as seen in FIG. 1 with the lace member in a configuration of securement with respect to the vest assembly and separated from engagement with the vest assembly;

FIG. 3 is the view of the canine ballistic carrier vest assembly as seen in FIG. 2, wherein first and second end portion of the torso section and an abdomen and chest section of the carrier vest are laced together;

FIG. 4 is a perspective view of the canine ballistic carrier vest assembly of FIG. 1, without the canine, showing the torso section first and second components joined together with a zipper assembly and backup securement assemblies of the torso section of the canine ballistic carrier vest assembly;

FIG. 5 is the perspective view of FIG. 4 with the backup securement for the ballistic carrier vest secured and a second portion of the abdominal and chest section in an unsecured position relative to the torso section;

FIG. 6 is the perspective view of FIG. 5 with a first end portion of the second portion of the abdominal and chest section being inserted into a first pocket of the torso section and a second end portion of the second portion of the abdominal and chest section being inserted into a second pocket of the torso section;

FIG. 7 is a cross section view along line 7-7 as seen in FIG. 6; and

FIG. 8 is a perspective view of the canine ballistic carrier vest fully secured without the canine present and showing a pocket assembly positioned on the abdominal and chest section of the vest.

### DESCRIPTION

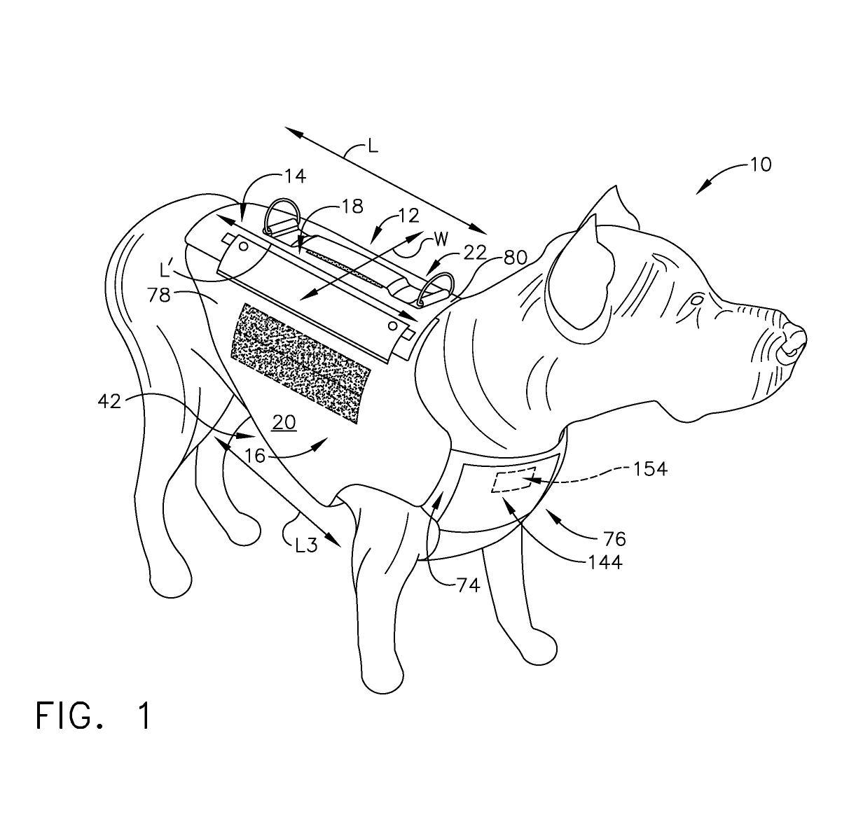

In referring to FIG. 1, canine 10 is wearing ballistic carrier assembly 12 in the performance of canine's duties. Ballistic carrier assembly 12 carries ballistic resistant panels (not shown) which protect canine 10 from ballistic threats. As discussed earlier, a handler at times has a need to secure carrier assembly 12 along canine 10 in a continuously snug fit to optimize the ballistic resistant panels performance for canine 10. At other times, the handler has a need to have carrier assembly 12 fit a little less snug on canine 10 to permit canine 10 to optimize the canine's movement and physical performance as well as breathing related to exertion. Overall, the ballistic carrier assembly 12 needs to provide the handler the ability to quickly position the ballistic carrier assembly 12 onto the canine to a desired fit and to similarly quickly adjustably conform the carrier assembly 12 to the torso of canine 10 as needed in the field as will be provided for ballistic carrier assembly 12.

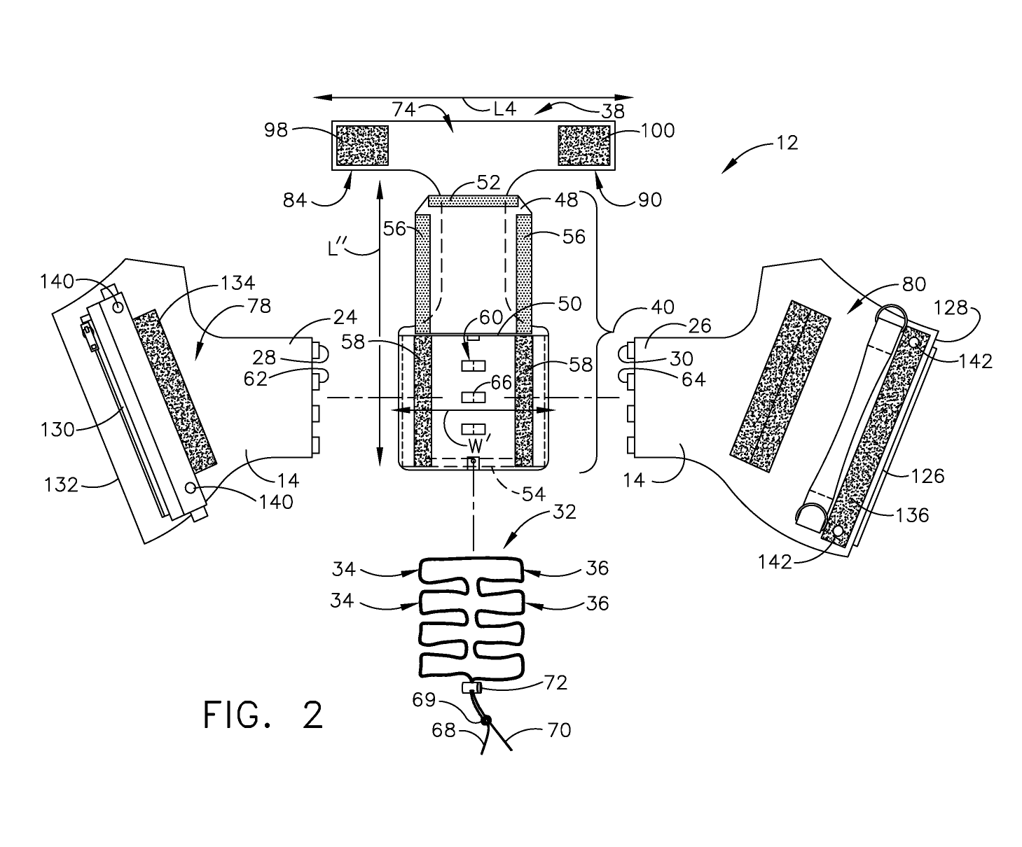

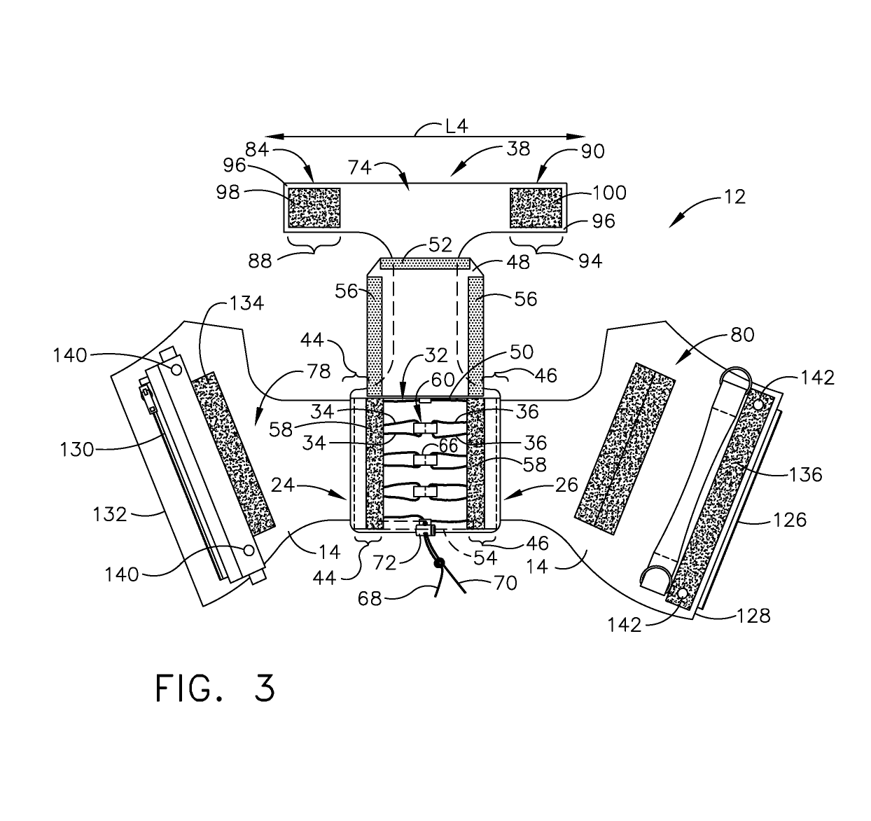

In referring to FIGS. 1-3, canine ballistic carrier assembly 12 includes torso section 14 for overlying torso 16 of canine 10. Torso section 14 includes length dimension L for extending along length L′ of back 18 of canine 10 with torso section 14 positioned on canine 10. Torso section 14 also includes a width dimension W for extending about opposing first and second sides 20, 22 of torso 16 of canine 10 with torso section 14 positioned on canine 10, such that torso section 14 which extends about the first side 20 extends to a first end portion 24 and torso section 14 which extends about the second side 22 extends to second end portion 26, as seen in FIG. 2. First loop 28 is associated with first end portion 24 of torso section 14 and second loop 30 is associated with second end portion 26 of torso section 14. Lace member 32 is shown in FIG. 2 uninstalled but in the configuration as if installed as shown in FIG. 3. Lace member 32 has first portion 34 for extending through first loop 28 and has second portion 36 for extending through second loop 30.

Ballistic carrier assembly 12 further includes an abdomen and chest section 38, as seen in FIGS. 2 and 3. First portion 40 has length dimension U′, as seen in FIG. 2, which extends along length L3 of abdomen 42 of canine 10, as seen in FIG. 1, with the abdomen and chest section 38 positioned on canine 10. First portion 40 has a width dimension W′ such that at least a portion 44 of first portion 40 of abdomen and chest section 38 is positionable in overlying relationship with respect to the first end portion 24 of torso section 14. In this example, first end portion 24 overlies at least a portion 44 of first portion 40 such that the at least a portion 44 is positioned against canine 10 with torso section 14 and abdomen and chest section 38 positioned on canine 10 and first end portion 24 overlies the at least a portion 44. At least another portion 46 of first portion 40 of abdomen and chest section 38 is positionable in overlying relationship with respect to second end portion 26 of torso section 14. In this example, second end portion 26 overlies at least another portion 46 of first portion 40 such that the at least another portion 46 is positioned against canine 10 with torso section 14 and abdomen and chest section 38 positioned on canine 10 and second end portion overlies the at least another portion 46. Overlapping of torso section 14 and abdomen and chest section 38 provides the needed ballistic coverage for canine 10.

First portion 40 of abdomen and chest section 38 further includes flap member 48. Flap member 48 includes first end 50 secured to first portion 40 of abdomen and chest section 38. Securement can be done in one of a variety of securements including stitching, bonding etc. Flap member 48 has first panel 52 which includes one of a plurality of hoop fasteners or a plurality loop fasteners secured to flap member 48. Abdomen and chest section 38 has second panel 54 which includes the other of the plurality of hoop fasteners or the plurality of loop fasteners of first panel 52 positioned on an opposing side of first panel 40. In this example, flap member 48 is sufficiently long enough such that with flap member 48 folded at first end 50 to overlie first portion 40, flap member 48 extends beyond first portion 40 such that first panel 52 can be folded to releasably engage second panel 54 on opposing side of first portion 40. As can be seen, additional panels 56 associated with flap member 48 and additional panels 58 associated with abdomen and chest section 38 can be employed to secure flap member 48 to first portion 40 of abdomen and chest section 38. With first and second panels 52, 54 releasably secured together, flap member 48 overlies first loop 28, second loop 30; first portion 34 of the lace member 32 extending through first loop 28 and second portion 36 of lace member 32 extending through second loop member 30.

First portion 34 of lace member 32 which extends through first loop 28 continues to extend to and through third loop member 60. Second portion 36 of lace member 32 which extends through second loop 30 continues to extend to and through third loop member 60. Third loop member 60 in this example defines two compartments in which first portion 34 and second portion 36 of lace member 32 can pass through separately. Other examples of third loop member 60 may include a single compartment or a number of compartments. In FIG. 2, first end portion 24 and second end portion 26 of torso section 14, are positioned in FIG. 3 overlying first portion 40 as described earlier and corresponding first and second loops 28, 30 are not seen positioned between additional panels 58 and first portion 40 of abdominal and chest section 38.

First portion 34 of lace member 32 which extends through third loop member 60 continues to extend to and through fourth loop 62 associated with first end portion 24 of torso section 14, as seen in FIGS. 2 and 3, wherein fourth loop 62 is positioned spaced apart from first loop 28, as seen in FIG. 2, associated with and in this example secured to first end portion 24 of torso section 14. Second portion 36 of lace member 32 which extends through third loop member 60 continues to extend to and through fifth loop 64, as seen in FIGS. 2 and 3. Fifth loop 64 is associated with second end portion 26 of torso section 14, in this example secured to second end portion 26, wherein fifth loop 64 is positioned spaced apart from second loop 30 associated with second end portion 26 of torso section 14. First portion 34 of lace member 32 which extends through fourth loop 62 continues to extend to and through sixth loop member 66 secured to first portion 40 of abdomen and chest section 38 and second portion 36 of lace member 32 which extends through fifth loop 64 continues to extend to and through sixth loop member 66.

First portion 34 of lace member 32 extends to first end 68 of lace member 32, as seen in FIGS. 2 and 3, positioned beyond third loop member 60 and second portion 36 of lace member 32 extends to second end 70 of lace member 32 positioned beyond the third loop member 60. In this example, lace member 32 has been threaded through a number of loops and loop members beyond third loop member 60. First portion 34 of lace member 32 and second portion 36 of lace member 32 are engaged together with adjustable cinch member 72 positioned between first and second ends 68, 70 of first and second portions 34, 36 respectively of lace member 32 on one side of adjustable cinch member 72 and third loop member 60 on another side of adjustable cinch member 72. Knot 69 of first and second portions 34, 36 of lace member 32 is secured into lace member 32. Knot 69 is spaced apart from first and second ends 68, 70 to inhibit adjustable cinch member 72 from sliding off of lace member 32 at first and second ends 68, 70. In this example, a number of loops and loop members have been threaded with lace member 32 beyond third loop member 60. In this arrangement lace member 32 is threaded through the loops and loop members such that the handler can easily grab lace member 32 proximate to ends 68, 70 and pull to more snuggly secure torso section 14 and abdomen and chest section 38 to canine 10 and then move adjustable cinch member 72 to a position closer to first portion 40 such that adjustable cinch member 72 further secures the adjusted fit position of torso section 14. With positioning adjustable cinch member 72 closer to first portion 40 adjustable cinch member 72 can also be positioned underneath flap member 48 such that an opportunity to snag adjustable cinch member 72 or any of the above described securement elements including lace member 32 and the loops and loop members are reliably hidden underneath flap member 48 with flap member 48 secured to first portion 40. For loosening the securement or fit of torso section 14 and abdomen and chest section 38 to canine 10, the handler can simply loosen adjustable cinch member 72 in a direction away from first portion 40 which permits the threaded lace member 32 to loosen the securement of torso section 14 and abdomen and chest section 38 and then re-position adjustable cinch member 72 such that flap member 48 reliably hides adjustable cinch member 72 and associated lace member 32 and loops and loop members from causing a potential snag condition with canine 10 in the field.

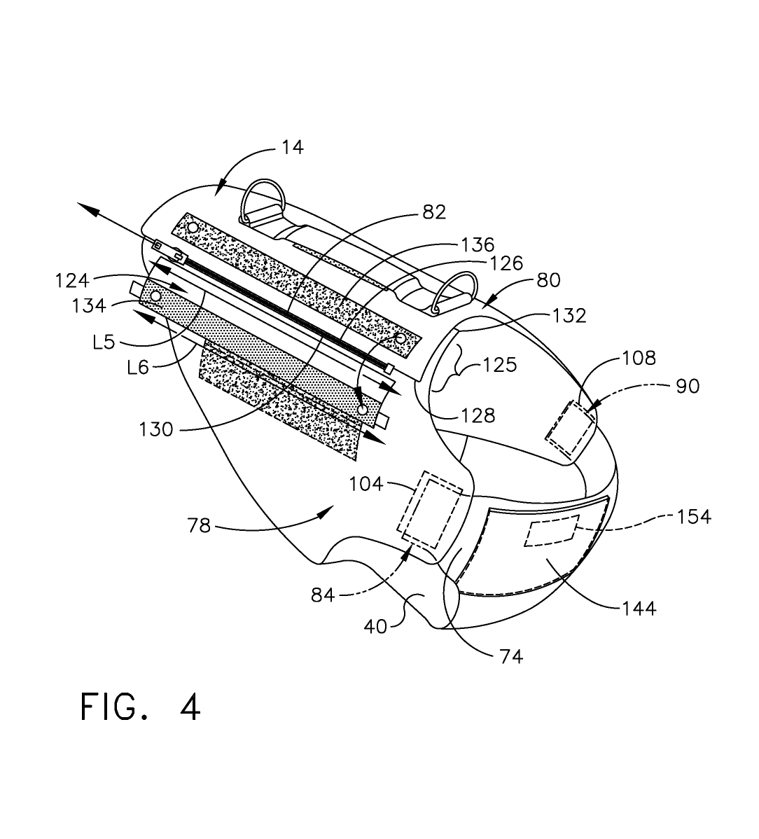

Abdomen and chest section 38 includes second portion 74 having length dimension L4 which extends transverse to length dimension L″ of first portion 40, as seen in FIG. 2, and which extends across chest 76 of canine 10 with abdomen and chest section 38 positioned on canine 10, as seen in FIG. 1. Torso section 14 includes in this example two separate components, first component 78 and second component 80, wherein each of first component 78 and second component 80 extends along length dimension L of torso section 14. Zipper assembly 82, as seen in FIG. 4, is associated with the first and second components 78 and 80 and releasably joins first and second components 78, 80 together. This zipper assembly 82 will be discussed further herein. Zipper assembly 82 secures torso section 14 along back 18 of canine 10 in one of the initial securement steps of positioning ballistic carrier assembly 12 to canine 10.

Another beneficial aspect of ballistic carrier garment 12 is that it also provides an adjustable securement for fitting the chest portion of the ballistic carrier garment 12 to a particular canine 10. Ballistic carrier garment 12 includes torso section 14 for overlying torso 16 of canine 10 which includes length dimension L of torso section 14 for extending along length L′ of back 18 of canine 10 as seen in FIG. 1. Further included is width dimension W of torso section 14 for extending about opposing first and second sides 20, 22 of torso 16 of canine 10 with torso section 14 positioned on canine 10, such that torso section 14 which extends about first side 20 extends to first end portion 24 and torso section 14 which extends about second side 22 extends to second end portion 26, as seen for example in FIG. 2. Further included is an abdomen and chest section 38 which includes first portion 40 which is positionable to overlie abdomen 42 of canine 10, having length dimension U′, as seen in FIG. 2, which extends along length L3 of abdomen 42, as seen in FIG. 1, of canine 10 with chest and abdomen section 38 positioned on canine 10 and first portion 40 is secured to torso section 14 with torso section 14 overlying torso 16 of canine 10.

An example of securement of first portion 40 to torso section 14 was discussed earlier with respect to utilization of lace member 32 being threaded for example through first loop 28, second loop 30, third loop member 60, fourth loop 62, fifth loop 64 and sixth loop member 66. Second portion 74 of abdomen and chest section 38 has length dimension L4 which extends transverse to length dimension L″ of first portion 40 and which extends across chest 76 of canine 10 with abdomen and chest section 38 position on canine 10, as seen in FIG. 1.

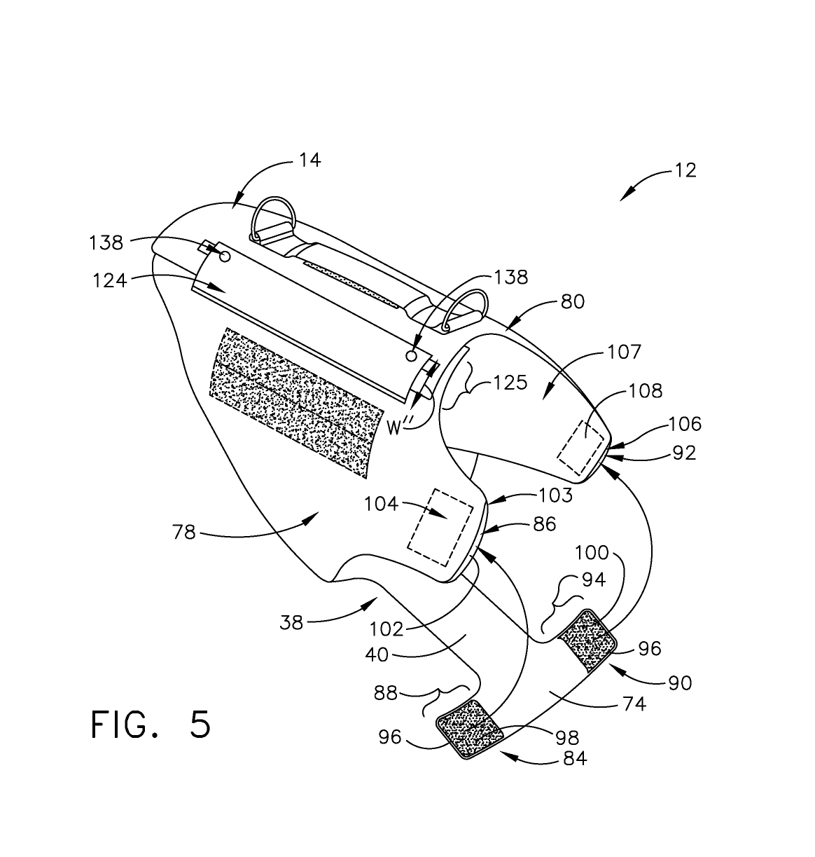

Second portion 74 of abdomen and chest section 38 includes first end portion 84, as seen in FIG. 5, and torso section 14, in this example, first component 78 of torso section 14, defines first pocket 86 for receiving at least a portion 88 of first end portion 84, as seen in FIGS. 4 and 5. Second portion 74 of abdomen and chest section 38 includes second end portion 90 and torso section 14, in this example, second component 80 of torso section 14, defines second pocket 92 for receiving at least a portion 94 of second end portion 90.

First end portion 84 of second portion 74 of abdomen and chest section 38 carries on first side 96 first panel 98 which includes one of a plurality of hook members or a plurality of loop members and second end portion 90 carries on first side 96 first panel 100 which includes one of a plurality of hook members or a plurality of loop members.

First pocket 86 includes first side surface 102, as seen in FIG. 5, is an inner surface within first pocket 86 of first wall section 103 wherein first wall section 103, in this example, is a part of first component 78 of torso section 14. First wall section 103 of first pocket 86 is positioned against the canine with ballistic carrier assembly 12 positioned on canine 10. First side surface 102 faces away from canine 10 with canine 10 wearing vest assembly 12 and first side surface 102 carries second panel 104, as seen in FIG. 5, which includes other of the plurality of hook members or plurality of loop members of first panel 98 carried on first side 96 of first end portion 84 of second portion 74 of abdomen and chest section 38 such that first panel 98 of first side 96 of first end portion 84 of second portion 74 of abdomen and chest section 38 is releasably securable to second panel 104 of first side surface 102 of first pocket 86 at a desired location within first pocket 86 with first end portion 84 inserted into first pocket 86. This configuration permits the handler to position the engagement of first panel 98 relative to second panel 104 so as to accommodate the size of chest 76 of canine 10. This arrangement is similar for second end portion 90 of second portion 74 of abdomen and chest section 38.

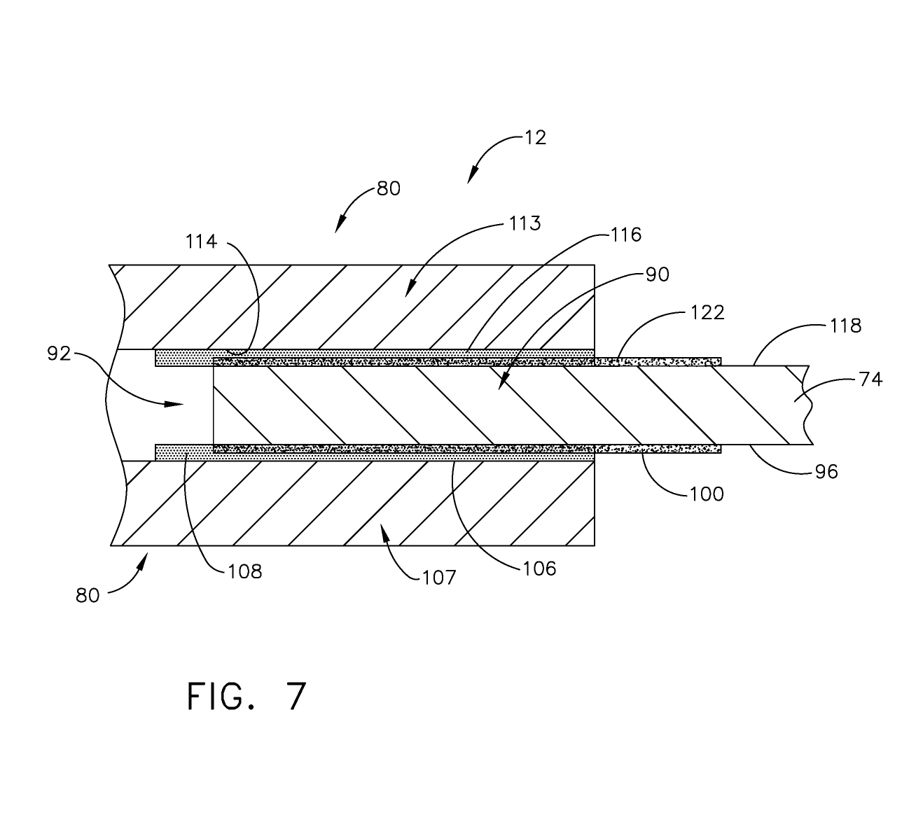

Similarly, second pocket 92 includes first side surface 106, as seen in FIGS. 5 and 7, is an inner surface within second pocket 92 of first wall section 107 wherein first wall section 107, in this example, is a part of second component 80 of torso section 14. First wall section 107 of second pocket 92 is positioned against the canine with ballistic carrier assembly 12 positioned on canine 10. First side surface 106 faces away from canine 10 with canine 10 wearing vest assembly 12 and first side surface 106 carries second panel 108, as seen in FIGS. 5 and 7. Second panel 108 which includes other of the plurality of hook members or plurality of loop members of first panel 100 carried on first side 96 of second end portion 90 of second portion 74 of abdomen and chest section 38 such that first panel 100 of first side 96 of second end portion 90 of second portion 74 of abdomen and chest section 38 is releasably securable to second panel 108 of first side surface 106 of second pocket 92 at a desired location within second pocket 92. This configuration permits the handler to position the engagement of first panel 100 relative to second panel 108 so as to accommodate the size of chest 76 of canine 10.

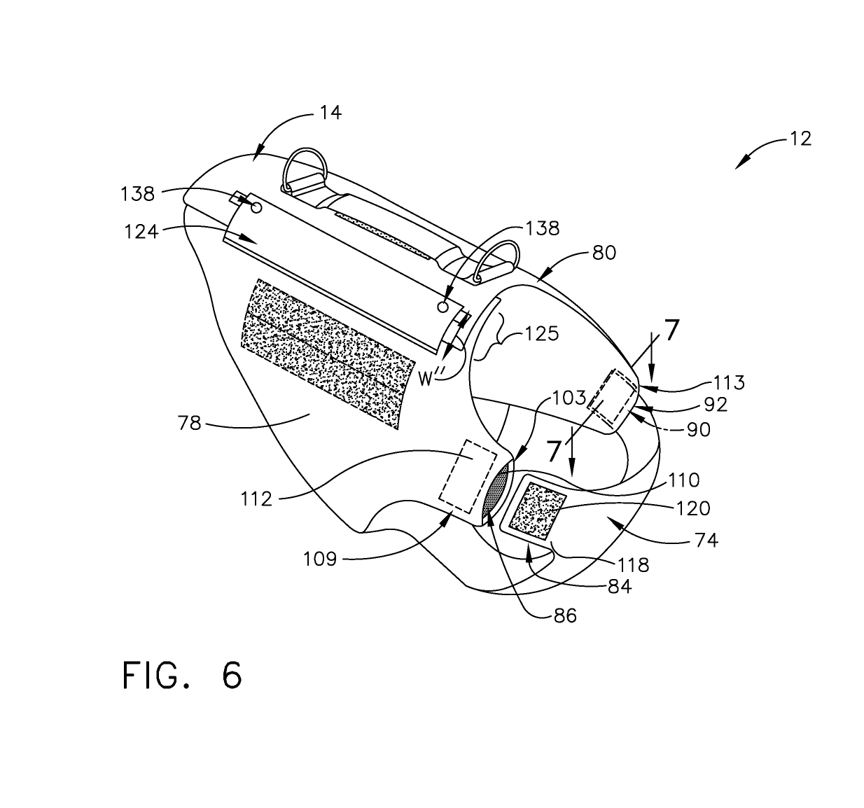

In referring to FIG. 6, first pocket 86 includes second side surface 110, which is an inner surface within first pocket 86 of second wall section 109 which is part of first component 78 of torso section 14. Second wall section 109 is positioned on an opposite side of first pocket 86 than first wall section 103. Second wall section 109 is positioned away from canine 10 and not against canine 10 with ballistic carrier vest assembly 12 positioned on canine 10. Second side surface 110 of second wall section 109 faces canine 10 with ballistic carrier vest assembly 12 positioned on canine 10. Second side surface 110 carries third panel 112 which includes one of a plurality of hook members or a plurality of loop members. This arrangement for first pocket 86 is the similar arrangement with respect to second pocket 92. Second pocket 92, as shown in FIGS. 5 and 7, include second side surface 114 which is an inner surface within second pocket 92 of second wall section 113 which is part of second component 80 of torso section 14. Second wall section 113 is positioned on an opposite side of second pocket 92 than first wall section 107. Second wall section 113 is positioned away from canine 10 and not against canine 10 with ballistic carrier vest assembly 12 positioned on canine 10. Second side surface 114 of second wall section 113 faces canine 10 with ballistic carrier vest assembly 12 positioned on canine 10. Second side surface 114 carries third panel 116 which includes one of a plurality of hook members or a plurality of loop members.

First end portion 84 of second portion 74 of abdomen and chest section 38 has second side 118 which carries fourth panel 120 which includes the other one of the plurality of hook members or the plurality of loop members of third panel 112 of second side surface 110 of first pocket 86. This configuration permits handler to insert first end portion 84 into first pocket 86 and secure fourth panel 116 to a desired location onto third panel 112 so as to accommodate the size of chest 76 of canine 10. This arrangement for securing fourth panel 120 to a desired location onto third panel 112 is similar to the arrangement with respect to second end portion 90 of second portion 74 of abdomen and chest section 38 being adjustably secured within second pocket 92. As shown in FIGS. 6 and 7, second end portion 90 is adjustably positioned and secured within second pocket 92.

In referring to FIGS. 6 and 7, second end portion 90 of second portion 74 of abdomen and chest section 38 has second side 118 which faces away from canine 10 with ballistic carrier vest assembly 12 positioned on canine 10. Second side 118 carries fourth panel 122. Fourth panel 122 which is carried by second end portion 90 includes the other one of the plurality of hook members or the plurality of loop members of third panel 116 of the second side surface 114 of second pocket 92. This configuration permits handler to insert second end portion 90 into second pocket 92 and secure a fourth panel to a desired location onto a third panel, as was done with respect to first pocket 86 so as to accommodate the size of chest 76 of canine 10.

As discussed earlier, torso section 14 extends in width dimension W from first end portion 24, in this example of first component 78 of torso section 14, to second end portion 26, in this example of second component 80 of torso section 14. First portion 40 of abdomen and chest section 38 is positioned in overlying relationship with respect to first end portion 24 of torso section 14 and in overlying relationship with the second end portion 26 of the torso section 14 with torso section 14 and abdomen and chest section 38 positioned on canine 10.

Another beneficial feature of canine ballistic carrier vest assembly 12 includes torso section 14 for overlying torso 16 of canine 10 which includes as discussed earlier length dimension L of torso section 14 for extending along length L′ of back 18 of canine 10. Torso section 14 further includes width dimension W for extending about opposing first and second sides 20, 22 of torso 16 of canine 10 with torso section 14 positioned on canine 10. Torso section 14, as mentioned earlier in this example, includes first component 78 and second component 80 with zipper assembly 82, as seen in FIG. 4, having length dimension L5 which extends along length dimension L of torso section 14, as seen in FIG. 1, for releasably joining first component 78 and second component 80 together. Zipper assembly 82 is associated with first component 78 and second component 80 wherein in this example zipper assembly 82 has a portion, as will be discussed below, connected to each of the first component and second component such that with closing zipper assembly 82 first and second components 78 and 80 are joined together and in this example, as will be discussed, assures overlapping protective relationship of second component 80 overlying first component 78.

Flap 124 is secured to one of first or second components 78, 80. In this example flap 124 is secured to first component 78, as seen in FIG. 4, by way of bonding, stitching or other conventional means of securing flap 124 to vest assembly 12. Flap 124 has length dimension L6 which extends along length dimension L5 of the zipper assembly 82. With zipper assembly 82 in a secured closed position, as seen in FIG. 4, joining first and second components 78, 80 together, flap 124, as seen in FIGS. 5 and 6, has width dimension W″ such that with flap 124 positioned in an overlying relationship with torso section 14, flap 124 overlies zipper assembly 82 in the secured closed position. With flap 124 in an overlying relationship with zipper assembly 82, canine 10 is more secure in that vest assembly 12 is less likely to be undone by way of canine 10 activity and flap 124 provides a non-extending profile with respect to vest assembly 12 such that canine 10 is less likely to have zipper assembly 82 ensnared with canine 10 carrying out duties in the field.

As can be seen in FIGS. 1 and 4-6, first component 78 and second component 80 of torso section 14 are in overlapping relationship to one another with torso section 14 positioned on canine 10. The overlapping relationship of first and second components 78 and 80 provide optimal ballistic coverage for canine 10 when in the field. First and second components 78 and 80 can be positioned in overlapping relationship based with either overlapping portion of either component being positioned against canine 10. In this example, second component 80 overlaps first component 78 with portion 125 of first component 78 positioned against canine 10 and positioned between canine 10 and second component 80.

In releasably securing first component 78 to second component 80, in this example, portion 126 of zipper assembly 82 is secured to edge 128 of second component 80, as seen in FIGS. 2-4. Another portion 130 of zipper assembly 82, in this example, is secured to first component 78 spaced apart from edge 132 of first component 78, as seen in FIGS. 2-4. This configuration permits first and second components 78 and 80 to be joined together with zipper assembly 82 and provide for first and second components 78 and 80 of torso section 14 to be positioned and secured in overlapping relationship to one another optimizing protection to canine 10. Alternatively, but similar to the arrangement of zipper assembly 82 above, based on a configuration wherein the first component 78 overlaps second component 80 and a portion of second component 80 is positioned between canine 10 and first component 78, the portion of the zipper assembly would be secured to an edge of second component 80 and another portion of zipper assembly 82 would secured spaced apart from an edge of second component 80.

Further included in this example is first panel 134, as seen in FIG. 2-4, secured to flap 124, which is secured to first component 78, wherein flap 124 includes one of a plurality of hook members or a plurality of loop members. Second panel 136, as seen in FIGS. 2-4, is secured to second component 80 of torso section 14 which includes other of the one of the plurality of hook members or the plurality of loop member of the first panel 134 such that flap 124 is releasably securable to second panel 136 with flap 124 in overlying relationship with torso section 14 and flap 124 overlying zipper assembly 82 in the secured closed position, as seen in FIGS. 4-6. In an alternative configuration, with flap 124, for example, secured to second component 80 of torso section 14, second panel 136 would be secured to first component 78 of torso component 14. Flap 124, when in a secured position overlying zipper assembly 82, provides further assurance that zipper assembly 82 can maintain a closed secured position to maintain protective positioning of first and second components 78, 80 to canine 10.

To further assure securement of flap 124 a mating snap connector assembly 138, wherein two are shown in this example in FIGS. 5 and 6. Snap connector assembly 138 is a releasable snap together connector such as dot snaps. Snap connector assembly 138 includes a first mating snap portion 140 of mating snap connector assembly 138 which is secured to flap 124 as seen in FIGS. 2 and 3. First mating snap portion 140 in this example includes a cap portion on one side of flap 124 secured to a male connector on the opposing side of flap 124. Second mating snap portion 142 of the mating snap connector assembly 138 is secured to the other of the first or second components 78, 80 of torso section 14 than to which the flap 124 is secured. In this example second mating snap portion 142 is secured to second component 80 of torso section 14. Second snap portion 142 in this example includes a cap portion on one side of second component 80 secured to a female connector on the opposing side of second component 80. In an alternative example, should flap 124 been secured to second component 80, second mating snap portion 142 would be secured to first component 78. The securement of mating snap connector assembly 138 provides additional securement for flap 124 thereby providing additional protection to zipper assembly 82 maintaining a secured position with the zipper assembly 82 in a closed position and maintaining a smooth profile for vest garment 12 thereby avoiding snag events with canine 10 operating in the field.

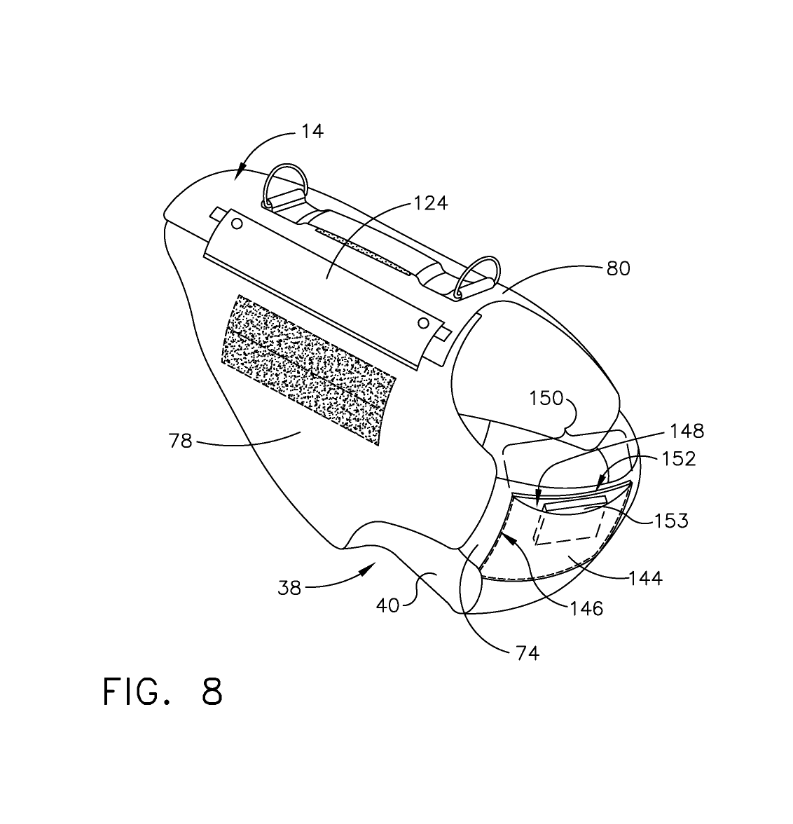

Another beneficial aspect with respect to canine ballistic carrier vest assembly 12 includes panel 144, as seen in FIG. 8. Panel 144 is secured to a portion, in this example second portion 74 of abdomen and chest section 38 of the canine ballistic carrier vest assembly 12, along a line 146 (schematically shown as a dashed line) of securement between the portion, in this example second portion 74 of abdomen and chest section 38, of ballistic carrier vest assembly 12 and panel 144. Line of securement 146 between panel 144 and the portion, in this example second portion 74 of the ballistic carrier vest assembly 12, forms an enclosure 148 positioned between the portion, second portion 74, of ballistic canine carrier vest assembly 12 and panel 144. Gap 150 positioned in line of securement 146 between panel 144 and the portion, second portion 74, of the ballistic carrier vest assembly 12 defines opening 152 between panel 144 and the portion, second portion 74, of the ballistic carrier vest assembly 12 wherein opening 152 is in communication with enclosure 148. At least a portion of panel 144 is constructed of an elastomeric material such as bungee cord or shock cord. The elastomeric material secures contents 153, shown being positioned into enclosure 148, which could include such important items as electronic transponder equipment, medical equipment etc. The elastomeric material not only provides securement of the contents within enclosure 148 but also provides a smooth surface boundary about the outer surface of panel 144 with contents positioned within enclosure 148 such that an external profile of panel 144 will inhibit snagging to items in the field of operation of canine 10.

In this example, panel 144 is positioned overlying the portion, such as second portion 74, of the canine ballistic carrier vest assembly 12 which is positioned to overlie chest 76 of canine 10 with canine ballistic carrier vest assembly 12 positioned on canine 10. Further included is first panel 154, as seen in FIG. 1, which includes one of a plurality of hook members or a plurality of loop members which faces the portion, second portion 74, of vest assembly 12, is secured to panel 144. Second panel (not shown), which includes the other of the plurality of hook members or the plurality of loop members, is secured to the portion, second portion 74, of the canine ballistic carrier vest assembly 12 which faces first panel 154 and is in alignment with first panel 154, such that first panel 154 and second panel (not shown) are releasably securable to one another.

While various embodiments have been described above, this disclosure is not intended to be limited thereto. Variations can be made to the disclosed embodiments that are still within the scope of the appended claims.

What is claimed:

1. A canine ballistic carrier vest assembly, comprising:
a torso section for overlying a torso of the canine which comprises:
a length dimension for extending along a length of a back of the canine with the torso section positioned on the canine; and
a width dimension for extending about opposing first and second sides of the torso of the canine with the torso section positioned on the canine, such that the torso section which extends about the first side extends to a first end portion and the torso section which extends about the second side extends to a second end portion; and
a first loop is associated with the first end portion of the torso section;
a second loop is associated with the second end portion of the torso section; and
a lace member has a first portion for extending through the first loop and has a second portion for extending through the second loop.

2. The canine ballistic carrier vest assembly of claim 1, further includes an abdomen and chest section, which comprises:
a first portion having a length dimension which extends along a length of an abdomen of the canine with the abdomen and chest section positioned on the canine; and
the first portion has a width dimension such that at least a portion of the first portion of the abdomen and chest section is positionable in overlying relationship with respect to the first end portion of the torso section and another portion of the first portion of the abdomen and chest section is positionable in overlying relationship with respect to the second end portion of the torso section with the torso section positioned on the canine.

3. The canine ballistic carrier vest assembly of claim 2, further including a flap member, wherein:
a first end of the flap member is secured to the first portion of the abdomen and chest section;
the flap member has a first panel comprising one of a plurality of hoop fasteners or a plurality loop fasteners secured to the flap member;
the abdomen and chest section has a second panel comprising the other of the plurality of hoop fasteners or the plurality of loop fasteners of the flap member such that the flap member is releasably securable to the abdomen and chest section; and
with the first and second panels releasably secured together, the flap member overlies the first loop, the second loop; the first portion of the lace member extending through the first loop and the second portion of the lace member extending through the second loop member.

4. The canine ballistic carrier vest assembly of claim 2, further including a third loop member secured to the first portion of the abdomen and chest section, wherein:
the first portion of the lace member which extends through the first loop continues to extend to and through the third loop member; and
the second portion of the lace member which extends through the second loop continues to extend to and through the third loop member.

5. The canine ballistic carrier vest assembly of claim 4, wherein:
the first portion of the lace member which extends through the third loop member continues to extend to and through a fourth loop associated with the first end portion of the torso section wherein the fourth loop is positioned spaced apart from the first loop associated with the first end portion of the torso section;
the second portion of the lace member which extends through the third loop member continues to extend to and through a fifth loop associated with the second end portion of the torso section wherein the fifth loop is positioned spaced apart from the second loop associated with the second end portion of the torso section; and
the first portion of the lace member which extends through the fourth loop continues to extend to and through a sixth loop member secured to the first portion of the abdomen and chest section and the second portion of the lace member which extends through the fifth loop continues to extend to and through the sixth loop member.

6. The canine ballistic carrier vest assembly of claim 4, wherein:
the first portion of the lace member extends to a first end of the lace member positioned beyond the third loop member and the second portion of the lace member extends to a second end of the lace member positioned beyond the third loop member; and
the first portion of the lace member and the second portion of the lace member are engaged together with an adjustable cinch member positioned between the first and second ends of the first and second portions of the lace member respectively on one side of the adjustable cinch member and the third loop member on another side of adjustable cinch member.

7. The canine ballistic carrier vest assembly of claim 2, wherein the abdomen and chest section comprises a second portion having a length dimension which extends transverse to length dimension of the first portion and which extends across the chest of the canine with the abdomen and chest section positioned on the canine.

8. The canine ballistic carrier vest assembly of claim 1, wherein:
the torso section comprises a first component and a second component wherein each of the first component and the second component extends along the length dimension of the torso section; and
a zipper assembly associated with the first and second components releasably joins the first and second components together.

9. A canine ballistic carrier vest assembly, comprising:
a torso section for overlying a torso of the canine which comprises:
a length dimension of the torso section for extending along a length of a back of the canine; and
a width dimension of the torso section for extending about opposing first and second sides of the torso of the canine with the torso section positioned on the canine, such that the torso section which extends about the first side extends to a first end portion and the torso section which extends about the second side extends to a second end portion; and
an abdomen and chest section includes:
a first portion of the abdomen and chest section is positionable to overlie the abdomen of the canine, having a length dimension, which extends along a length of the abdomen of the canine with the chest and abdomen section positioned on the canine and the first portion is secured to the torso section with the torso section overlying the torso of the canine;
a second portion of the abdomen and chest section having a length dimension which extends transverse to the length dimension of the first portion and which extends across the chest of the canine with the abdomen and chest section position on the canine;
the second portion of the abdomen and chest section includes a first end portion and the torso section defines a first pocket for receiving at least a portion of the first end portion; and
the second portion of the abdomen and chest section includes a second end portion and the torso section defines a second pocket for receiving at least a portion of the second end portion.

10. The canine ballistic carrier vest assembly of claim 9, wherein:
the first end portion of the second portion of the abdomen and chest section carries on a first side a first panel which includes one of a plurality of hook members or a plurality of loop members and the second end portion carries on a first side a first panel which includes one of a plurality of hook members or a plurality of loop members;
the first pocket comprises a first side surface which carries a second panel which includes the other of the plurality of hook members or plurality of loop members of the first panel carried on the first side of first end portion of the second portion of the abdomen and chest section such that the first panel of the first side of the first end portion of the second portion of the abdomen and chest section is releasably securable to the second panel of the first side surface of the first pocket at a desired location within the first pocket; and
the second pocket comprises a first side surface which carries a second panel which includes the other of the plurality of hook members or plurality of loop members of the first panel carried on the first side of the second end portion of the second portion of the abdomen and chest section such that the first panel of the first side of the second end portion of the second portion of the abdomen and chest section is releasably securable to the second panel of the first side surface of the second pocket at a desired location within the second pocket.

11. The canine ballistic carrier vest assembly of claim 10, wherein:
the first pocket comprises a second side surface which carries a third panel which includes one of a plurality of hook members or a plurality of loop members; and
the second pocket comprises a second side surface which carries a third panel which includes one of a plurality of hook members or a plurality of loop members.

12. The canine ballistic carrier assembly of claim 11, wherein:
the first end portion of the second portion of the abdomen and chest section has a second side which carries a fourth panel which includes the other one of the plurality of hook members or the plurality of loop members of the third panel of the second side surface of the first pocket; and
the second end portion of the second portion of the abdomen and chest section has a second side which carries a fourth panel which includes the other one of the plurality of hook members or the plurality of loop members of the third panel of the second side surface of the second pocket.

13. The canine ballistic carrier vest assembly of claim 9 wherein:
the torso section extends in the width dimension from a first end portion of the torso section to a second end portion of the torso section; and
the first portion of the abdomen and chest section is positioned in overlying relationship with respect to the first end portion of the torso section and in overlying relationship with the second end portion of the torso section with the torso section and the abdomen and chest section positioned on the canine.

14. A canine ballistic carrier vest assembly, comprising:
a torso section for overlying a torso of the canine which comprises:
a length dimension of the torso section for extending along a length of a back of the canine;
a width dimension of the torso section for extending about opposing first and second sides of the torso of the canine with the torso section positioned on the canine; and
the torso section comprises a first component and a second component, which are in overlapping relationship to one another with the torso section positioned on the canine, with a zipper assembly, associated with the first component and the second component, having a length dimension which extends along the length dimension of the torso section for releasably joining the first component and the second component together, wherein a portion of the zipper assembly is secured to an edge of one of the first or second components and another portion of the zipper assembly is secured spaced apart from an edge of the other of the one of the first or second components; and
a flap secured to one of the first or second components has a length dimension which extends along the length dimension of the zipper assembly with the zipper assembly in a secured closed position joining the first and second components together wherein the flap has a width dimension such that with the flap positioned in an overlying relationship with the torso section the flap overlies the zipper assembly in the secured closed position.

15. The canine ballistic carrier vest assembly of claim 14, further including:
a first panel secured to the flap includes one of a plurality of hook members or a plurality of loop members; and
a second panel, secured to the other of the first or second components of the torso section than to which the flap is secured, includes the other of the one of the plurality of hook members or the plurality of loop members of the first panel, such that the flap is releasably securable to the second panel with the flap in the overlying relationship with the torso section and the flap overlying the zipper assembly in the secured closed position.

16. The canine ballistic carrier vest assembly of claim 15, further including:
a mating snap connector assembly, comprises:
a first mating snap portion of the mating snap connector assembly secured to the flap; and
a second mating snap portion of the mating snap connector is secured to the other of the first or second components of the torso section than to which the flap is secured,

17. A canine ballistic carrier vest assembly, comprising:
a panel is secured to a portion of the canine ballistic carrier vest assembly along a line of securement between the portion of the ballistic carrier vest assembly and the panel, wherein:
the line of securement between the panel and the portion of the ballistic carrier vest assembly forms an enclosure positioned between the portion of the ballistic canine carrier vest assembly and the panel; and
a gap positioned in the line of securement between the panel and the portion of the ballistic carrier vest assembly defines an opening between the panel and the portion of the ballistic carrier vest assembly wherein the opening is in communication with the enclosure; and
at least a portion of the panel is constructed of an elastomeric material.

18. The canine ballistic carrier vest assembly of claim 17, wherein the panel is positioned overlying the portion of the canine ballistic carrier vest assembly which is positioned to overlie a chest of the canine with the canine ballistic carrier vest assembly positioned on a canine, and further including:
a first panel, which includes one of a plurality of hook members or a plurality of loop members, is secured to the panel; and
a second panel which includes the other of the plurality of hook members or the plurality of loop members is secured to the portion of the canine ballistic carrier vest assembly such that the first and second panels are releasably securable to one another.
